(19) United States
(12) Patent Application Publication
(10) Pub. No.: US 2023/0126484 A1
(43) Pub. Date: Apr. 27, 2023

(54) THERMAL DEVICE

(71) Applicant: General Electric Company, Schenectady, NY (US)

(72) Inventor: Jeffrey Douglas Rambo, Mason, OH (US)

(21) Appl. No.: 17/506,761

(22) Filed: Oct. 21, 2021

(51) Int. Cl. F02C 7/18; F02C 7/04; F02C 7/14

(52) U.S. Cl. CPC F02C 7/18; F02C 7/04; F02C 7/14; F28D 2021/0021

(57) ABSTRACT

A thermal device includes a plate defining a plurality of convex curves and a plurality of concave curves. Each convex curve is positioned between a pair of adjacent concave curves of the plurality of concave curves. Each concave curve is positioned between a pair of adjacent convex curves of the plurality of convex curves. Each concave curve defines a vertex. The thermal device also includes a plurality of pins. Each pin of the plurality of pins extends from the vertex of a different concave curve of the plurality of concave curves and extends away from the plate.

### FIELD

The present disclosure relates to a thermal device, such as a thermal device for a gas turbine engine.

### BACKGROUND

Typical aircraft propulsion systems include one or more gas turbine engines. The gas turbine engines generally include a turbomachine, the turbomachine including, in serial flow order, a compressor section, a combustion section, a turbine section, and an exhaust section. In operation, air is provided to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

Certain operations and systems of the gas turbine engine and aircraft may generate a relatively large amount of heat. Thermal devices can receive at least some of such heat during operations. For example, a heat exchanger can use a relatively cool fluid, such as fuel, to receive some of the heat from a relatively hot fluid, such as a lubricant. The inventors of the present disclosure have come up with various configurations and devices to improve on currently known thermal devices.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of an exemplary additive manufacturing system or machine, according to an exemplary embodiment.

FIG. 2 is a schematic, cross-sectional view of a gas turbine engine, according to an exemplary embodiment.

FIG. 3 is a partial, perspective view of a thermal device, according to an exemplary embodiment.

FIG. 4A is a partial, side view of the thermal device of FIG. 3, according to an exemplary embodiment.

FIG. 4B is a partial, side view of the thermal device of FIG. 3, according to an exemplary embodiment.

FIG. 4C depicts a close-up, cross-sectional view of an intended design of a pin of the thermal device of FIG. 4B, according to an exemplary embodiment.

FIG. 4D depicts a close-up, cross-sectional view of the pin of the thermal device of FIG. 4C, as fabricated, according to an exemplary embodiment.

FIG. 5 is a partial, side view of a thermal device, according to an exemplary embodiment.

FIG. 6 is a partial, side view of the thermal device of FIG. 5, according to an exemplary embodiment.

FIG. 7 is a partial, side view of the thermal device of FIG. 5, according to an exemplary embodiment.

FIG. 8 is a perspective view of the thermal device of FIG. 5, according to an exemplary embodiment.

FIG. 9 is a partial, side view of the thermal device of FIG. 5 on a build platform of an additive manufacturing machine, according to an exemplary embodiment.

FIG. 10 is a partial, side view of the thermal device of FIG. 5 on a build platform of an additive manufacturing machine, according to an exemplary embodiment.

FIG. 11 is a partial, side view of the thermal device of FIG. 5 on a build platform of an additive manufacturing machine, according to an exemplary embodiment.

FIG. 12 is a partial, cross-sectional, side view of a thermal device, according to at least one example embodiment, according to an exemplary embodiment.

FIG. 13 is a schematic view of a control system associated with an additive manufacturing machine, according to an exemplary embodiment.

FIG. 14 is a schematic view of a method of additively manufacturing a thermal device, according to an exemplary embodiment.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

As described herein, the presently disclosed subject matter involves the use of additive manufacturing machines or systems. As used herein, the term “additive manufacturing” refers generally to manufacturing technology in which components are manufactured in a layer-by-layer manner. An exemplary additive manufacturing machine may be configured to utilize any desired additive manufacturing technology. The additive manufacturing machine may utilize an additive manufacturing technology that includes a powder bed fusion (PBF) technology, such as a direct metal laser melting (DMLM) technology, a selective laser melting (SLM) technology, a directed metal laser sintering (DMLS) technology, or a selective laser sintering (SLS) technology. In an exemplary PBF technology, thin layers of powder material are sequentially applied to a build plane and then selectively melted or fused to one another in a layer-by-layer manner to form one or more three-dimensional objects. Additively manufactured objects are generally monolithic in nature and may have a variety of integral sub-components.

Additionally or alternatively suitable additive manufacturing technologies include, for example, Fused Deposition Modeling (FDM) technology, Direct Energy Deposition (DED) technology, Laser Engineered Net Shaping (LENS) technology, Laser Net Shape Manufacturing (LNSM) technology, Direct Metal Deposition (DMD) technology, Digital Light Processing (DLP) technology, Vat Polymerization (VP) technology, Stereolithography (SLA) technology, and other additive manufacturing technology that utilizes an energy beam.

Additive manufacturing technology may generally be described as fabrication of objects by building objects point-by-point, layer-by-layer, typically in a vertical direction V, which is perpendicular to a horizontal direction H. Other methods of fabrication are contemplated and within the scope of the present disclosure. For example, although the discussion herein refers to the addition of material to form successive layers, the presently disclosed subject matter may be practiced with any additive manufacturing technology or other manufacturing technology, including layer-additive processes, layer-subtractive processes, or hybrid processes.

The additive manufacturing processes described herein may be used for forming components using any suitable material. For example, the material may be metal, ceramic, polymer, epoxy, photopolymer resin, plastic, concrete, or any other suitable material that may be in solid, liquid, powder, sheet material, wire, or any other suitable form. Each successive layer may be, for example, between about 10 μm and 200 μm, although the thickness may be determined based on any number of parameters and may be any suitable size.

As used herein, the term “build plane” refers to a plane defined by a surface upon which an energy beam impinges during an additive manufacturing process. Generally, the surface of a powder bed defines the build plane. During irradiation of a respective layer of the powder bed, a previously irradiated portion of the respective layer may define a portion of the build plane, and/or prior to distributing powder material across a build module, a build plate that supports the powder bed generally defines the build plane.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The term “fluid” may be a gas or a liquid. The term “fluid communication” means that a fluid is capable of making the connection between the areas specified.

The term “thermal communication” means that heat is capable of being transferred between the areas specified.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers only A, only B, only C, or any combination of A, B, and C.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine.

As used herein, the terms “integral”, “unitary”, or “monolithic” as used to describe a structure refers to the structure being formed integrally of a continuous material or group of materials with no seams, connections joints, or the like. The integral, unitary structures described herein may be formed through additive manufacturing to have the described structure, or alternatively through a casting process, etc.

The present disclosure is generally related to a thermal device, such as a thermal device for a gas turbine engine. The thermal device can be provided to cool certain systems of the gas turbine engine or of the aircraft that the gas turbine engine is installed upon. For example, the thermal device can be provided to cool one or more heat generating components, such as a gearbox, a bearing, a pump, a fan blade pitch change mechanism, a motor-generator, or an airfoil, to name a few.

In one example, the thermal device can cool these components by cooling a relatively hot fluid, such as a lubricant that is delivered to those components, with a relatively cool fluid, such as a fuel, a cooling gas, such as air, a dielectric fluid, a synthetic heat transfer fluid, or a supercritical fluid. When fuel is used as a coolant fluid, instead of other coolant fluids such as supercritical fluids, dielectric fluids, air, or synthetic heat transfer fluids, the heat exchange system can have the additional benefit of heating the fuel. Heating the fuel of a gas turbine engine can increase the efficiency of the engine by reducing the amount of fuel needed to achieve desired combustor firing temperatures. Additionally, heating the fuel can improve the power output of the gas turbine engine.

In at least one example, the thermal device can include a plate and a plurality of pins. The plate can define a plurality of convex curves and a plurality of concave curves. Each convex curve can be positioned between a pair of adjacent concave curves of the plurality of concave curves, and each concave curve can be positioned between a pair of adjacent convex curves of the plurality of convex curves. Each concave curve can define a vertex. Each pin of the plurality of pins can extend from the vertex of a different concave curve of the plurality of concave curves and extending away from the plate.

As will be appreciated from the discussion herein, this configuration has several benefits. For example, the convex curves and the concave curves may cause the fluid passing through the thermal device to continuously mix and turbulate as it traverses through the thermal device. This mixing and turbulating can increase the amount of heat transferred to or from the fluid. Additionally, the convex curves and the concave curves may increase the structural strength of the thermal device, which may allow the thermal device to withstand greater fluid pressures. Also, when the thermal device is manufactured with an additive manufacturing process, the convex curves and/or the concave curves may decrease the amount of distortion caused by the manufacturing process.

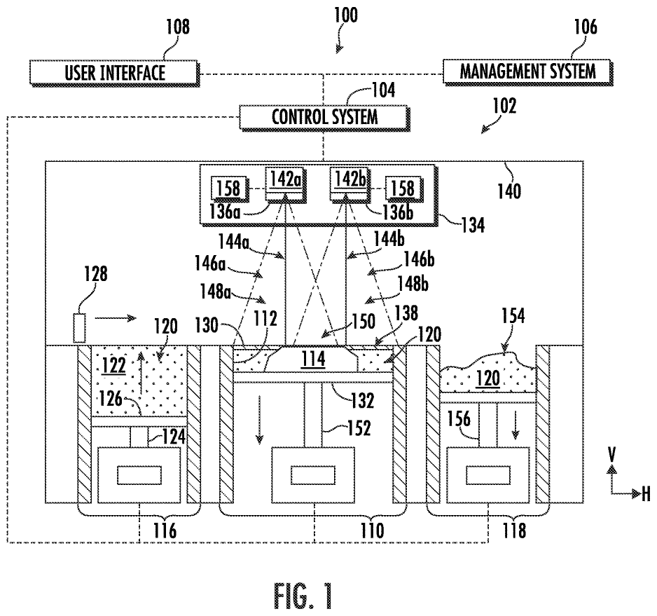

Referring now to the drawings, wherein identical numerals indicate the same elements throughout the figures, FIG. 1 is an exemplary additive manufacturing system 100. The additive manufacturing system 100 may include one or more additive manufacturing machines 102. The one or more additive manufacturing machines 102 may include a control system 104. The control system 104 may be included as part of the additive manufacturing machine 102 or the control system 104 may be associated with the additive manufacturing machine 102. The control system 104 may include componentry integrated as part of the additive manufacturing machine 102 and/or componentry that is provided separately from the additive manufacturing machine 102. Various componentry of the control system 104 may be communicatively coupled to various componentry of the additive manufacturing machine 102.

The control system 104 may be communicatively coupled with a management system 106 and/or a user interface 108. The management system 106 may be configured to interact with the control system 104 in connection with enterprise-level operations pertaining to the additive manufacturing system 100. Such enterprise level operations may include transmitting data from the management system 106 to the control system 104 and/or transmitting data from the control system 104 to the management system 106. The user interface 108 may include one or more user input/output devices to allow a user to interact with the additive manufacturing system 100.

As shown, the additive manufacturing machine 102 may include a build module 110 that includes a build chamber 112 within which an object 114 or objects 114 may be additively manufactured. The additive manufacturing machine 102 may include a powder module 116 and/or an overflow module 118. The build module 110, the powder module 116, and/or the overflow module 118 may be provided in the form of modular containers configured to be installed into and removed from the additive manufacturing machine 102 such as in an assembly-line process. Additionally, or in the alternative, the build module 110, the powder module 116, and/or the overflow module 118 may define a fixed componentry of the additive manufacturing machine 102.

The powder module 116 contains a supply of powder material 120 housed within a supply chamber 122. The powder module 116 includes a powder piston 124 that elevates a powder floor 126 during operation of the additive manufacturing machine 102. As the powder floor 126 elevates, a portion of the powder material 120 is forced out of the powder module 116. A recoater 128 such as a blade or roller sequentially distributes thin layers of powder material 120 across a build plane 130 above the build module 110. A build platform 132 supports the sequential layers of powder material 120 distributed across the build plane 130. The build platform 132 may include a build plate (not shown) secured thereto and upon which the object 114 may be additively manufactured.

The additive manufacturing machine 102 includes an energy beam system 134 configured to generate one or more of energy beams, such as energy beams 144a and/or 144b, which can be laser beams. The additive manufacturing machine 102 can direct the respective energy beams 144a and/or 144b onto the build plane 130 to selectively solidify respective portions of a powder bed 138 defining the build plane 130. As the respective energy beams 144a and/or 144b selectively melt or fuse the sequential layers of powder material 120 that define the powder bed 138, the object 114 begins to take shape. The one or more energy beams 144a and/or 144b or laser beams may include electromagnetic radiation having any suitable wavelength or wavelength range, such as a wavelength or wavelength range corresponding to infrared light, visible light, and/or ultraviolet light.

Typically, with a DMLM, EBM, or SLM system, the powder material 120 is fully melted, with respective layers being melted or re-melted with respective passes of the energy beams 144a and/or 144b. With DMLS or SLS systems, typically the layers of powder material 120 are sintered, fusing particles of powder material 120 to one another generally without reaching the melting point of the powder material 120. The energy beam system 134 may include componentry integrated as part of the additive manufacturing machine 102 and/or componentry that is provided separately from the additive manufacturing machine 102.

The energy beam system 134 may include one or more irradiation devices 142 configured to generate the plurality of energy beams 144a and/or 144b and to direct the energy beams 144a and/or 144b upon the build plane 130. The irradiation devices 142 may respectively have an energy beam source, a galvo-scanner, and an optical assembly, such as optical assembly 136a or 136b, that includes a plurality of optical elements configured to direct the energy beam 144a and/or 144b onto the build plane 130. The optical assembly 136a and/or 136b may include one or more optical elements, such as lenses through which the energy beam 144a and/or 144b may be transmitted along an optical path from the energy beam source to the build plane. By way of example, the optical assembly 136a and/or 136b may include one more focusing lenses that focus the energy beam 144a and/or 144b on the build plane 130. Additionally, or in the alternative, the optical assembly 136a and/or 136b may include a window, such as a protective glass, that separates one or more components of the energy beam system 134 from a process chamber 140 within which powder material 120 is irradiated by one or more energy beams 144a and/or 144b to additively manufacture the object 114. The window or protective glass may include one or more optical elements, such as lenses or panes, through which an energy beam 144a and/or 144b passes along an optical path to the build plane 130. The window or protective glass may separate the one or more components of the energy beam system 134 from conditions existing within the process chamber 140 of the additive manufacturing machine 102. Such window or protective glass may prevent contaminants associated with the additive manufacturing process, such as powder material 120, dust, soot, residues from fumes or vapor, and the like, from coming into contact with sensitive components of the energy beam system 134. Accumulation of contaminants upon various optical elements of the optical assembly 136a and/or 136b may adversely affect operation of the energy beam system 134 and/or quality metrics associated with the energy beam system 134. Additionally, or in the alternative, such contaminants may cause damage to various optical elements of the optical assembly 136a or 136b. The presently disclosed optical element monitoring systems may be configured to monitor various optical elements of the optical assembly 136a and/or 136b for accumulation of contaminants and/or damage. Additionally, or in the alternative, the presently disclosed optical element monitoring systems may be configured to initiate cleaning, maintenance, and/or replacement of various optical elements of the optical assembly 136a or 136b.

As shown in FIG. 1, the energy beam system 134 includes a first irradiation device 142a and a second irradiation device 142b. The first irradiation device 142a may include the first optical assembly 136a, and/or the second irradiation device 142b may include the second optical assembly 136b. Additionally, or in the alternative, the energy beam system 134 may include three, four, six, eight, ten, or more irradiation devices 142, and such irradiation devices 142 may respectively include the optical assembly 136a or 136b. The plurality of irradiation devices 142 may be configured to respectively generate the one or more energy beams 144a and/or 144b that are respectively scannable within a scan field incident upon at least a portion of the build plane 130. For example, the first irradiation device 142a may generate a first energy beam 144a that is scannable within a first scan field 146a incident upon at least a first build plane region 148a. The second irradiation device 142b may generate a second energy beam 144b that is scannable within a second scan field 146b incident upon at least a second build plane region 148b. The first scan field 146a and the second scan field 146b may overlap such that the first build plane region 148a scannable by the first energy beam 144a overlaps with the second build plane region 148b scannable by the second energy beam 144b. The overlapping portion of the first build plane region 148a and the second build plane region 148b may sometimes be referred to as an interlace region 150. Portions of the powder bed 138 to be irradiated within the interlace region 150 may be irradiated by the first energy beam 144a and/or the second energy beam 144b in accordance with the present disclosure.

To irradiate a layer of the powder bed 138, the one or more irradiation devices 142 (e.g., the first irradiation device 142a and the second irradiation device 142b) respectively direct the plurality of energy beams 144a and 144b across the respective portions of the build plane 130 (e.g., the first build plane region 148a and the second build plane region 148b) to melt or fuse the portions of the powder material 120 that are to become part of the object 114. The first layer or series of layers of the powder bed 138 are typically melted or fused to the build platform 132, and then sequential layers of the powder bed 138 are melted or fused to one another to additively manufacture the object 114. As sequential layers of the powder bed 138 are melted or fused to one another, a build piston 152 gradually lowers the build platform 132 to make room for the recoater 128 to distribute sequential layers of powder material 120. The distribution of powder material 120 across the build plane 130 to form the sequential layers of the powder bed 138, and/or the irradiation imparted to the powder bed 138, may introduce contaminants, such as powder material 120, dust, soot, residues from fumes or vapor, and the like, into the environment of the process chamber 140. Such contaminants may accumulate on various optical elements of the optical assembly 136a and/or 136b associated with the energy beam system 134.

As the build piston 152 gradually lowers and sequential layers of powder material 120 are applied across the build plane 130, the next sequential layer of powder material 120 defines the surface of the powder bed 138 coinciding with the build plane 130. Sequential layers of the powder bed 138 may be selectively melted or fused until a completed object 114 has been additively manufactured. The additive manufacturing machine 102 may utilize the overflow module 118 to capture excess powder material 120 in an overflow chamber 154. The overflow module 118 may include an overflow piston 156 that gradually lowers to make room within the overflow chamber 154 for additional excess powder material 120.

It will be appreciated that the additive manufacturing machine 102 may not utilize the powder module 116 and/or the overflow module 118, and that other systems may be provided for handling the powder material 120, including different powder supply systems and/or excess powder recapture systems. The subject matter of the present disclosure may be practiced with any suitable additive manufacturing machine 102 without departing from the scope hereof.

Still referring to FIG. 1, the additive manufacturing machine 102 may include an imaging system 158 configured to monitor one or more operating parameters of the additive manufacturing machine 102, one or more parameters of the energy beam system 134, and/or one or more operating parameters of an additive manufacturing process. The imaging system 158 may include a calibration system configured to calibrate one or more operating parameters of the additive manufacturing machine 102 and/or of an additive manufacturing process. The imaging system 158 may be a melt pool monitoring system. The one or more operating parameters of the additive manufacturing process may include operating parameters associated with additively manufacturing the object 114. The imaging system 158 may be configured to detect an imaging beam such as an infrared beam from a laser diode and/or a reflected portion of an energy beam (e.g., the first energy beam 144a and/or the second energy beam 144b).

The energy beam system 134 and/or the imaging system 158 may include one or more detection devices. The one or more detection devices may be configured to determine one or more parameters of the energy beam system 134, such as one or more parameters associated with irradiating the sequential layers of the powder bed 138 based at least in part on an assessment beam detected by the imaging system 158. One or more parameters associated with irradiating the sequential layers of the powder bed 138 may include irradiation parameters and/or object parameters, such as melt pool monitoring parameters. The one or more parameters determined by the imaging system 158 may be utilized, for example, by the control system 104, to control one or more operations of the additive manufacturing machine 102 and/or of the additive manufacturing system 100. The one or more detection devices may be configured to obtain assessment data of the build plane 130 from a respective assessment beam. An exemplary detection device may include a camera, an image sensor, a photo diode assembly, or the like. For example, a detection device may include charge-coupled device (e.g., a CCD sensor), an active-pixel sensor (e.g., a CMOS sensor), a quanta image device (e.g., a QIS sensor), or the like. A detection device may additionally include a lens assembly configured to focus an assessment beam along a beam path to the detection device. The imaging system 158 may include one or more imaging optical elements (not shown), such as mirrors, beam splitters, lenses, and the like, configured to direct an assessment beam to a corresponding detection device.

In addition or in the alternative to determining parameters associated with irradiation the sequential layers of the powder bed 138, the imaging system 158 may be configured to perform one or more calibration operations associated with the additive manufacturing machine 102, such as a calibration operation associated with the energy beam system 134, the one or more irradiation devices 142 or components thereof, and/or the imaging system 158 or components thereof. The imaging system 158 may be configured to project an assessment beam and to detect a portion of the assessment beam reflected from the build plane 130. The assessment beam may be projected by the irradiation device 142 and/or a separate beam source associated with the imaging system 158. Additionally, and/or in the alternative, the imaging system 158 may be configured to detect an assessment beam that includes radiation emitted from the build plane 130, such as radiation from the energy beams 144a or 144b reflected from the powder bed 138 and/or radiation emitted from a melt pool in the powder bed 138 generated by the energy beams 144a or 144b and/or radiation emitted from a portion of the powder bed 138 adjacent to the melt pool. The imaging system 158 may include componentry integrated as part of the additive manufacturing machine 102 and/or componentry that is provided separately from the additive manufacturing machine 102. For example, the imaging system 158 may include componentry integrated as part of the energy beam system 134. Additionally, or in the alternative, the imaging system 158 may include separate componentry, such as in the form of an assembly, that can be installed as part of the energy beam system 134 and/or as part of the additive manufacturing machine 102.

As mentioned, the additive manufacturing machine 102 can be used to additively manufacture the object 114. In some examples, the object 114 is a component for a gas turbine engine. For example, the additive manufacturing machine 102 can be used to additively manufacture a thermal device for a gas turbine engine, which will be explained in more detail, below. In some examples, other manufacturing methods may be used to manufacture the thermal device for a gas turbine engine. For example, the thermal device may be manufactured from a casting. The casting, in some examples, can be created from a mould and/or a core. The mould or the core can be additively manufactured.

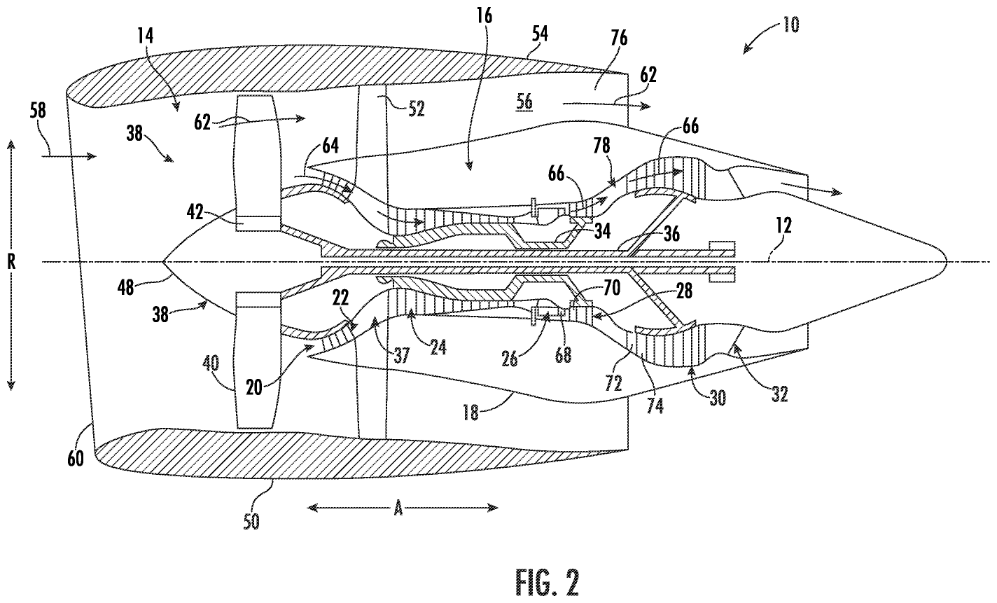

FIG. 2 is a schematic, cross-sectional view of a gas turbine engine in accordance with an exemplary embodiment of the present disclosure. More particularly, for the embodiment of FIG. 2, the gas turbine engine is a high-bypass turbofan jet engine, referred to herein as “turbofan engine 10.” As shown in FIG. 2, the turbofan engine 10 defines an axial direction A (extending parallel to a longitudinal centerline 12 provided for reference) and a radial direction R. In general, the turbofan engine 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22. The compressor section, combustion section 26, turbine section, and jet exhaust nozzle section 32 together define a core air flowpath 37.

For the embodiment depicted, the fan section 14 includes a fan 38 having a plurality of fan blades 40 coupled to a rotor disk 42 in a spaced apart manner. As depicted, the fan blades 40 extend outwardly from rotor disk 42 generally along the radial direction R. The rotor disk 42 is covered by a rotatable front hub 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the turbomachine 16. It should be appreciated that the nacelle 50 may be configured to be supported relative to the turbomachine 16 by a plurality of circumferentially-spaced outlet guide vanes 52. Moreover, a downstream section 54 of the nacelle 50 may extend over an outer portion of the turbomachine 16 so as to define a bypass airflow passage 56 therebetween.

During operation of the turbofan engine 10, a volume of air 58 enters the turbofan engine 10 through an associated inlet 60 of the nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the core air flowpath 37, or more specifically into the LP compressor 22. The ratio between the first portion of air 62 and the second portion of air 64 is commonly known as a bypass ratio. The pressure of the second portion of air 64 is then increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan engine 10, also providing propulsive thrust. The HP turbine 28, the LP turbine 30, and the jet exhaust nozzle section 32 at least partially define a hot gas path 78 for routing the combustion gases 66 through the turbomachine 16.

It should be appreciated, however, that the exemplary turbofan engine 10 depicted in FIG. 2 is by way of example only, and that in other exemplary embodiments, the turbofan engine 10 may have any other suitable configuration. For example, in other exemplary embodiments, the fan 38 may be configured as a variable pitch fan including, e.g., a suitable actuation assembly for rotating the plurality of fan blades about respective pitch axes, the turbofan engine 10 may be configured as a geared turbofan engine having a reduction gearbox between the LP shaft or spool 36 and fan section 14, etc. It should also be appreciated, that in still other exemplary embodiments, aspects of the present disclosure may be incorporated into any other suitable gas turbine engine. For example, in other exemplary embodiments, aspects of the present disclosure may be incorporated into, e.g., turboprop engine.

Certain operations and systems of the turbofan engine 10 and aircraft on which it is installed may generate a relatively large amount of heat. For example, a heat generating component, such as a gear or a bearing, generate heat during operation. A cooling system that includes a thermal device can be provided to cool the heat generating component. For example, a cooling system, such as a lubrication system, that includes a thermal device, such as a heat exchanger, can be provided to be in thermal communication with the heat generating component and cool the heat generating component, such as a gear or a bearing. More specifically, a fluid passage through the heat exchanger can include a relatively cool fluid, such as a fuel or a supercritical fluid, and another fluid passage through the heat exchanger can include a lubricant to be cooled, which is a relatively hot fluid. The lubricant, once cooled by the thermal device, in this case a heat exchanger, would be provided to cool the heat generating component.

In some examples, the heat generating component is an airfoil, such as a rotor blade or a turbine blade, such as turbine rotor blades 70 and/or 74, within the gas turbine engine. A cooling system that includes a thermal device can be provided to cool the airfoil. More specifically, a cooling system can provide relatively cool air to the inner cavity of the airfoil; a thermal device can be included within the airfoil to assist with heat transfer from the airfoil to the relatively cool air.

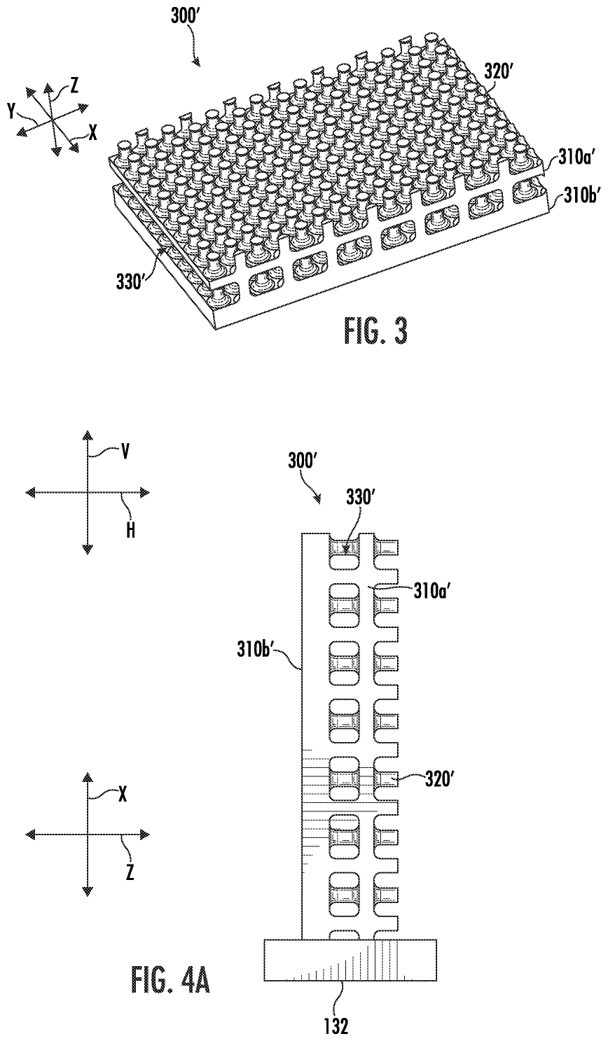

Referring now to FIG. 3, a partial, perspective view of a thermal device 300′ is depicted, according to at least one example embodiment. The thermal device 300′ defines an X direction, a Y direction, and a Z direction. Each of the X, Y, and Z direction are perpendicular to each other. The thermal device 300′ includes a first plate 310a′, a second plate 310b′, and a plurality of pins 320′ extending from the first plate 310a′ to the second plate 310b′, in this example. The first plate 310a′ and the second plate 310b′ can each extend along planes defined by the X and Y directions and can be separated from each other to define a fluid passage 330′ therebetween. The pins 320′ can extend in the Z direction and can make contact with both the first plate 310a′ and the second plate 310b′. Each of the sets of plurality of pins 320′ can extend from a plate to an adjacent plate, such as from plate 310a′ to plate 310b′. In this example, the plates 310′ are planar and each of the pins 320′ are cylindrical.

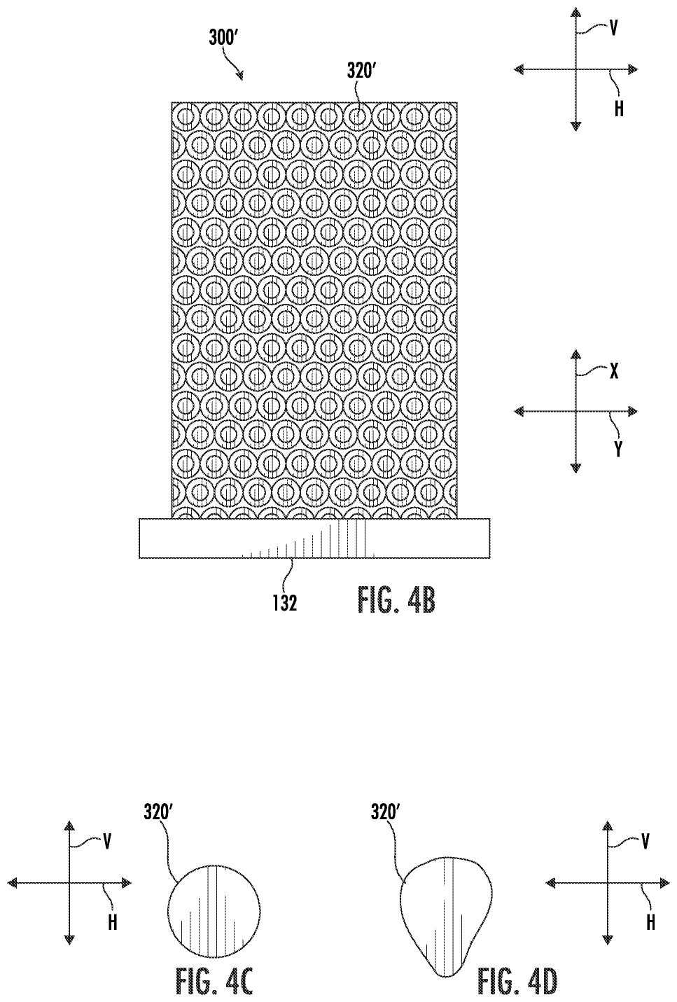

Referring now to FIGS. 4A and 4B, partial, side views of the thermal device 300′ of FIG. 3 are depicted, according to at least one example embodiment. In this example, the thermal device 300′ was fabricated on the build platform 132 of the additive manufacturing machine 102 of FIG. 1 and is shown still positioned on the build platform 132. As mentioned, additive manufacturing technology may fabricate the object 114, such as the thermal device 300′, by building the object 114 point-by-point, layer-by-layer, typically in a vertical direction V, which is perpendicular to a horizontal direction H. The build platform 132 defines a plane that extends along the horizontal direction H.

In this example, the thermal device 300′ was fabricated in an upward, vertical direction V. Also in this example, the thermal device 300′ was fabricated such that the X direction defined by the thermal device 300′ is generally parallel to the vertical direction V. Also, the first plate 310a′ and the second plate 310b′, which each extend along planes defined by the X and Y directions, are each parallel to the vertical direction V and perpendicular to the build platform 132. The pins 320′, which extend in the Z direction, are each perpendicular to the vertical direction V, in this example.

Referring now to FIGS. 4C and 4D, FIG. 4C depicts a close-up, cross-sectional view of an intended design of a pin 320′ of the thermal device 300′ of FIG. 4B, and FIG. 4D depicts a close-up, cross-sectional view of the pin 320′ of the thermal device 300′ of FIG. 4C, as fabricated, according to at least one example embodiment. As shown in FIG. 4C, the cross-section of the pin 320′ is designed to be circular such that it creates a pin 320′ that is cylindrical. However, as can be seen in FIG. 4D, the pin 320′ may become distorted once fabricated so that the cross-section of the pin 320′ is not circular.

As mentioned, the additive manufacturing process may use energy beams energy beams 144a and/or 144b to melt or fuse sequential layers of powder material 120 to fabricate the object 114, as described in FIG. 1. However, the melted portions of the powder material 120 are impacted by gravity and may cause distortions, such as the drooping of the pin 320′ in the downward, vertical direction V, as shown in FIG. 4D. These distortions can cause portions of the fluid passage 330′ (FIG. 4A) between the plates 310′ to become blocked, either partially or fully. The blockages within the fluid passage 330′ may cause the thermal device 300′ to not work as effectively in heating and/or cooling the fluids that flow within the fluid passage 330′. As such, these distortions are undesirable.

Notably, even if the build direction of the thermal device 300′ was altered such that the Z direction of the thermal device 300′ was parallel to the V axis, a similar undesirable fabrication issue may be present. For example, the plates 310′ could experience drooping because they would be fabricated such that they extend in the horizontal direction H.

Referring now to FIG. 5, a partial, side view of a thermal device 300 is shown, according to at least one example embodiment. The thermal device 300 defines an X direction (in and out of the page), a Y direction, and a Z direction. Each of the X, Y, and Z direction are perpendicular to each other. The thermal device 300 can be configured as a pin array thermal device. For example, the thermal device 300 can be configured as a pin array heat exchanger.

As shown, the thermal device 300 includes a first surface 311a and a second surface 311b. The thermal device 300 includes a plate 310 that defines a plurality of convex curves 312 and a plurality of concave curves 314. Each convex curve 312 can be positioned between a pair of adjacent concave curves 314 of the plurality of concave curves 314, and each concave curve 314 can be positioned between a pair of adjacent convex curves 312 of the plurality of convex curves 312 Each concave curve 314 defines a vertex 316 and each convex curve 312 defines a vertex 316. As used herein, a “concave curve” opens toward the negative z-axis and a “convex curve” opens towards the positive z-axis.

As shown, the thermal device 300 includes a first plurality of pins 320a Each pin 320 of the first plurality of pins 320a extends from the vertex 316 of a different concave curve 314 of the plurality of concave curves 314 and extends away from the plate 310. Also as shown, the thermal device 300 includes a second plurality of pins 320b. Each pin 320 of the second plurality of pins 320b extends from the vertex 316 of a different convex curve 312 of the plurality of convex curves 312 and extends away from the plate 310. As used herein, the term “pin” is not to be limited to a shape that is pin shaped or cylindrical in shape, even though it can be. As will be explained later, each of the pins 320 can be any shape.

The plate 310 of the thermal device 300 can define a first continuous wave 318a that includes the plurality of convex curves 312 and the plurality of concave curves 314. In this view, the first continuous wave 318a extends generally along the Y direction. Even though the first continuous wave 318a is depicted as a sinusoidal wave in this example, it should be understood that other types of waves are contemplated. For example, the first continuous wave 318a could include a series of compound curves. Also, even though the term “wave” is used, it should also be understood that any type of generally repeating shape is contemplated. For example, the first continuous wave 318a could have pointed vertexes such that the first continuous wave 318a is a series of repeating triangular shapes.

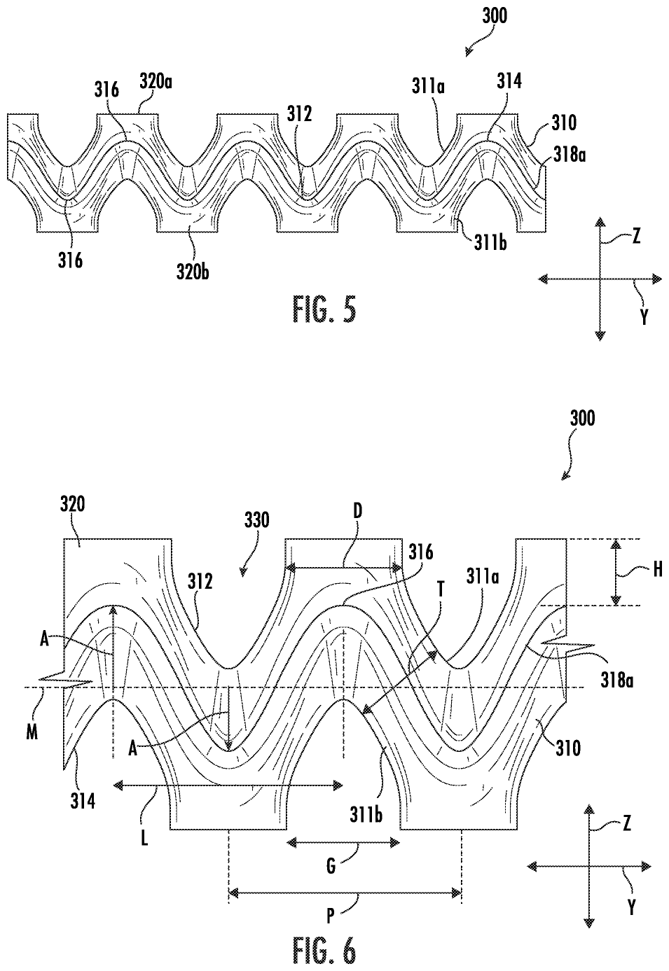

Referring now to FIG. 6, a partial, side view of the thermal device 300 of FIG. 5 is shown, according to at least one example embodiment. The plate 310 can define a thickness T, which is the shortest difference from the first surface 311a of the plate 310 to the opposite side of the plate 310, the second surface 311b. Each pin 320 can define a pin diameter D and a pin height H. Each pin 320 and an adjacent pin 320 can define a pin-to-pin gap G and a pin pitch P. The pin-to-pin gap G is the distance from an outer circumference of one pin 320 to an adjacent pin 320. The term “adjacent pin” refers to a pin 320 that is located on the same continuous wave as the subject pin 320, is a pin 320 that is closest in proximity to the subject pin 320, and a pin 320 that extends in the same general direction away from the respective plate 310 as the subject pin 320.

The first continuous wave 318a can define a midline M, a wave amplitude A, and a wavelength L. The midline M is the line about which the continuous wave oscillates above and below. In this example, the pin pitch P is equal to the wavelength L. Each concave curve 314 and each convex curve 312 define a wave amplitude A. The wave amplitude A is the distance between the midline M and the vertex 316 of the respective concave curve 314 or convex curve 312.

In some examples, a ratio (H:A) between a pin height H of at least one of the plurality of pins 320 and a wave amplitude A of the respective concave curve 314 or convex curve 312 is at least 0.5:1, such as at least 1:1 and up to 5:1, such as at least 1.2:1 and up to 3:1, such as at least 1.5:1 and up to 2:1. Having an H:A ratio that is at least 0.5:1 may have several advantages. For example, having an H:A ratio that is at least 0.5:1 increases the area of the respective fluid passage 330, as compared to having an H:A ratio that is less than 0.5:1. This increased area of the respective fluid passage 330 may reduce the pressure loss of the fluid flowing within the respective fluid passage 330 of the thermal device 300. Also, the increased area of the respective fluid passage 330 may reduce the amount of pressure within the respective fluid passage 330, which may increase the mechanical durability of the thermal device 300 under pressure loading. Additionally, having an H:A ratio that is at least 0.5:1 may increase the amount of mixing or turbulation of the fluid flowing through the respective fluid passage 330, as compared to having an H:A ratio that is less than 0.5:1 because of the more prominent pins 320, which may result in the thermal device 300 having an increased heat transfer rate.

In some examples, the thickness of the plate T can be greater than or equal to 0.010 inch. For example, the thickness of the plate T can be at least 0.010 inch and up to 0.500 inch, such as at least 0.010 inch and up to 0.200 inch, such as at least 0.010 inch and up to 0.1 inch. Having the thickness of the plate T to be greater than or equal to 0.010 inch can result in a thermal device that can withstand high pressure applications, such as the high pressures experienced in thermal devices 300 installed on gas turbine engines. For example, the thermal device 300 may be able to withstand pressures of five hundred pounds per square inch (psi) or higher, such as between five hundred psi and up to three thousand psi, such as between eight hundred psi and up to two thousand psi.

In some examples, the thickness of the plate T can be generally uniform throughout the plate 310. For example, the thickness of the plate T may not vary through the plate. For example, the variation of the thickness of the plate T, throughout the plate 310, may be less than or equal to 0.200 inch, such as less than or equal to 0.100 inch, such as less than or equal to 0.050 inch, such as less than or equal to 0.010 inch. In other examples, the thickness of the plate T varies through the plate. For example, the variation of the thickness of the plate T may be greater than 0.200 inch, such as greater than 0.200 inch and less than 1.000 inch, such as greater than 0.200 inch and less than 0.500 inch.

In some examples, a ratio (P:D) between a pin pitch P and a pin diameter D can be at least 1.5:1, such as at least 1.5:1 and up to 4:1, such as at least 1.5:1 and up to 3:1, such as at least 1.8:1 and up to 2.2:1. Having a P:D ratio that is at least 1.5:1 may have several advantages, as compared to having a P:D ratio that is less than 1.5:1. For example, having an P:D ratio that is at least 0.5:1 increases the area of the respective fluid passage 330, as compared to having an P:D ratio that is less than 0.5:1. This increased area of the respective fluid passage 330 may reduce the pressure loss of the fluid flowing within the respective fluid passage 330 of the thermal device 300. Also, the increased area of the respective fluid passage 330 may reduce the amount of pressure within the respective fluid passage 330, which may increase the mechanical durability of the thermal device 300 under pressure loading.

In some examples, the pin pitch P can be generally uniform throughout the plate 310 such that each pin pitch P of each of the pins 320 associated with the plate 310 vary by less than or equal to ten percent, such as less than or equal to eight percent, such as less than or equal to five percent, such as less than or equal to three percent, such as less than or equal to one percent. Similarly, the pin pitch can be generally uniform throughout the thermal device 300 such that each pin pitch P of each of the pins 320 associated with the thermal device 300 vary by less than or equal to ten percent, such as less than or equal to eight percent, such as less than or equal to five percent, such as less than or equal to three percent, such as less than or equal to one percent.

In some examples, a ratio (T:D) between the thickness of the plate T and the pin diameter D is at least 0:5:1, such as at least 0:5:1 and up to 2:1, such as at least 0.7:1 and up to 1.3:1, such as at least 0.8:1 and up to 1.2:1. Having a T:D ratio that is at least 0.5:1 may have several benefits, as compared to having a T:D ratio that is less than 0:5:1. For example, having a T:D ratio that is at least 0.5:1 provides a thicker plate, which may increase the mechanical durability of the thermal device 300 under pressure loading.

In some examples, the pin diameter D is at least 0.010 inch, such as at least 0.010 inch and up to 0.100 inch, such as at least 0.010 inch and up to 0.050 inch, such as at least 0.010 inch and up to 0.040 inch, such as at least 0.020 inch and up to 0.030 inch.

In some examples, the pin height H is at least 0.010 inch, such as at least 0.010 inch and up to 0.100 inch, such as at least 0.010 inch and up to 0.050 inch, such as at least 0.010 inch and up to 0.040 inch, such as at least 0.020 inch and up to 0.030 inch.

In some examples, a ratio (H:D) between the pin height H and the pin diameter D is greater than or equal to 1:1 and less than or equal to 4:1. For example, the ratio H:D can be greater than or equal to 1:1 and less than or equal to 2.5:1. In another example, the ratio H:D can be greater than equal to 2.5:1 and less than or equal to 4:1.

In some examples, a ratio (T:D) between the thickness T of the plate 310 and the pin diameter D is less than or equal to 1:1. A T:D ratio of less than or equal to 1:1 allows for an increase in the heat transferred to the plates. In some examples, T:D is less than or equal to 1:1 and the thickness T of the plate 310 is at least 0.010 inch, which allows for an increase in the heat transferred to the plates and for the plates to be able to withstand greater pressures, such as five hundred psi or higher.

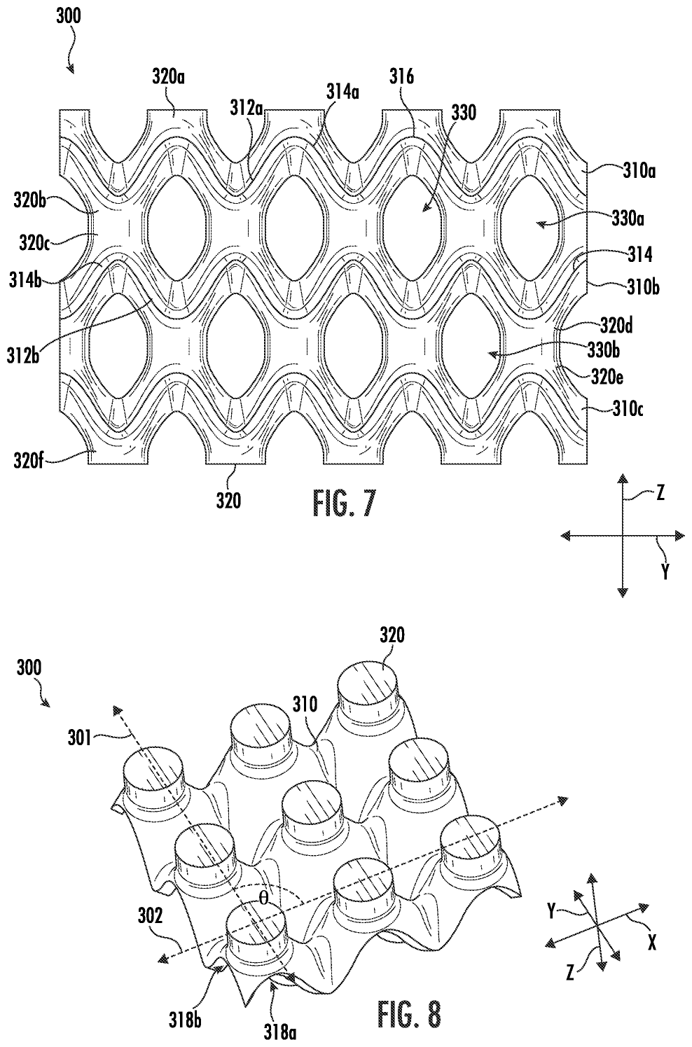

Referring now to FIG. 7, a partial, side view of the thermal device 300 of FIG. 5 is shown, according to at least one example embodiment. As mentioned, the thermal device 300 includes the plate 310, the first plurality of pins 320a, and the second plurality of pins 320b, which were described in reference to FIG. 5. In this example, the plate 310 is a first plate 310a and the thermal device 300 includes a second plate 310b defining a second plurality of convex curves 312b and a second plurality of concave curves 314b. Each convex curve 312 can be positioned between a pair of adjacent concave curves 314 of the second plurality of concave curves 314b, and each concave curve 314 can be positioned between a pair of adjacent convex curves 312 of the second plurality of convex curves 312b, each concave curve 314 defining a vertex 316.

The thermal device 300 can also include a third plurality of pins 320c. As shown, each pin 320 of the third plurality of pins 320c extends from the vertex 316 of a different concave curve 314 of the second plurality of concave curves 314b and extends away from the second plate 310b and towards the first plate 310a. Each of the pins 320 of the third plurality of pins 320c can be connected to a different pin 320 of the second plurality of pins 320b. As used in the context of the pins 320 being connected, the term “connected” means physically connected so that they are physically joined into a unitary portion of the thermal device 300.

In this example, the thermal device 300 also includes a third plate 310c and a fourth plurality of pins 320d, a fifth plurality of pins 320e, and a sixth plurality of pins 320f However, it should be understood that the thermal device 300 could include any number of plates 310 and any number of plurality of pins 320.

Even though not depicted, the planes defined by the plates 310 of the thermal device 300 may not be parallel to each other. For example, the planes of the plates 310 could converge from a first location to a second location or diverge from the first location to the second location. When the planes of the plates 310 diverge, this can create fluid passages 330 through the thermal device 300 that expand in size, which may slow the flow of the fluid flowing through the fluid passages 330. Slowing the flow of the fluid flowing through the fluid passages 330 may increase the effectiveness of the thermal device 300. For example, it may increase an amount of heat exchanged in or out of the fluid flowing through the fluid passages 330.

As can be seen best in the view of FIG. 7, having pins 320 extending from the plurality of concave curves 314, extending from the plurality of convex curves 312, and extending away from the respective plate 310 creates a thermal device 300 design that includes a staggered orientation of the pins 320 in the Z direction. This staggered orientation may create a more uniform heat distribution through the thermal device 300, which may increase the heat exchange effectiveness of the thermal device 300 and may reduce thermal stresses. Also, the staggered orientation of the pins 320 in the Z direction may direct more heat into the respective plates 310, causing the heat to diffuse into the respective plates 310, which may create a more uniform temperature profile through the thermal device 300, as compared to an aligned orientation of the pins 320 in the Z direction, which may cause hot spots at the base of the pins 320 and relatively cooler regions between the pins 320. Having a more uniform temperature profile through the thermal device 300 may reduce thermal stresses.

Additionally, the staggered orientation may increase the structural integrity of the thermal device 300, which may allow the thermal device 300 to withstand greater pressures. For example, the thermal device 300 may be able to withstand pressures of five hundred psi or higher, such as between five hundred psi and up to three thousand psi, such as between eight hundred psi and up to two thousand psi.

Referring briefly back to the example of FIG. 3, the thermal device 300′ can have a staggered orientation of the pins 320′ in the Z direction. The staggered orientation of the pins 320′ in the Z direction may have the same benefits as the staggered orientation as discussed in reference to thermal device 300.

Referring now to FIG. 8, a perspective view of the thermal device 300 of FIG. 5 is shown, according to one example embodiment. As mentioned, the thermal device 300 can include the first continuous wave 318a that extends generally along the Y direction, which is depicted as a first direction 301. In this depiction, the plate 310 defines a second continuous wave 318b that includes a plurality of concave curves 314 and a plurality of convex curves 312, as best seen in FIG. 5. As shown, the second continuous wave 318b extends generally along the X direction, which, in this example, is depicted as a second direction 302. As such, an angle θ between first continuous wave 318a and the second continuous wave 318b can be approximately ninety degrees. As shown, the first continuous wave 318a and the second continuous wave 318b can extend along the plate 310 to form an ‘egg crate’ shape on the plate 310.

In other examples, the angle between the first continuous wave 318a and the second continuous wave 318b can be different than ninety degrees. For example, the first continuous wave 318a can extend in the first direction 301 and the second continuous wave 318b can extend in the second direction 302. The first direction 301 can be defined by a line that extends between the vertex 316 (FIG. 5) of each of the concave curves 314 of the first continuous wave 318a and the second direction 302 can be defined by a line that extends between each of the vertexes 316 of the concave curves 314 of the second continuous wave 318b. As mentioned, the angle between the first direction 301 and the second direction 302 can be ninety degrees. In other examples, the angle between the first direction 301 and the second direction 302 can be not equal to ninety degrees, such as between seventy and eighty nine degrees or ninety one degrees and one-hundred and ten degrees.

As best seen in this view, each of the pins of the plurality of pins 320 are cylindrical. However, the pins 320 can be any shape. For example, they can be in the shape of an elliptic cylinder, a tetrahedron, a triangular prism, a hexagonal prism, or a cuboid, to name a few. Additionally, the pins 320 may include other features, such as ridges, which may increase mixing and turbulation of the fluids passing through the thermal device 300.

Referring briefly back to FIG. 7, a relatively hot fluid can pass through the fluid passage 330a defined between the first plate 310a and the second plate 310b, when the thermal device 300 is in operation. A relatively cool fluid can pass through the fluid passage 330b defined between the second plate 310b and the third plate 310c, when the thermal device 300 is in operation. As the fluids pass through their respective fluid passages 330, heat is exchanged from the relatively hot fluid within fluid passage 330a to the relatively cool fluid within fluid passage 330b. Heat is exchanged from fluid passage 330a to fluid passage 330b because fluid passage 330a is in thermal communication with fluid passage 330b, via the plate 310b that is between them.

The relatively cool fluid can be a gas, liquid, or a supercritical fluid. For example, the relatively cool fluid can be a fuel. In another example, the relatively cool fluid can be a supercritical fluid such as supercritical carbon dioxide. In yet another example, the relatively cool fluid can be a gas, such as air, that is extracted from a compressor section of a gas turbine engine, such as turbomachine 16 of FIG. 2, or can be ambient air. The relatively hot fluid can be a gas or a liquid. For example, the relatively hot fluid can be an oil or a lubrication fluid.

Referring again to FIG. 8, the relatively hot fluid and the relatively cool fluid can each pass through the thermal device 300 in any direction. For example, the hot fluid may pass through the thermal device 300 in the positive X direction and the relatively cool fluid can pass through the thermal device 300 in the positive Y direction, such that they are in cross flow. In other examples, both the relatively hot fluid and the relatively cool fluid can pass through the thermal device 300 in the same direction, for example, they can both pass through the thermal device 300 in the positive X direction, such that they are in parallel flow. In yet another example, the relatively hot fluid can pass through the thermal device 300 in the positive X direction and the relatively cool fluid can pass through the thermal device 300 in the negative X direction, such that they are in counter flow. In still yet another example, at least one of the relatively hot fluid or the relatively cool fluid can pass through the thermal device a direction that is not parallel to either the X direction or the Y direction.

In some examples, which are not shown, the first direction 301 or the second direction 302 are non-linear. For example, the first direction 301 or the second direction 302 can be curved. As such, the fluids passing through the fluid passages 330 may take a non-linear path as it traverses through the thermal device 300.

In some examples, which are not shown, the plate 310 does not extend completely on a plane that is defined by the X direction and the Y direction. Instead, the plate 310 may bow away from the plane that is defined by the X direction and the Y direction such that the plate 310 of the thermal device 300 has an overall curved shape. This curved shape of the plate 310 of the thermal device 300 may be beneficial when installed within or around, partially or fully, the outer casing 18 of a gas turbine engine, such as turbofan engine 10 of FIG. 2. Because the outer casing 18 of the gas turbine engine has a circular cross-sectional shape, the curve plate of the thermal device 300 can conform to the shape of the outer casing 18, which may be beneficial.

In comparison to the thermal device 300′ of FIG. 3, the thermal device 300 as described in reference to FIG. 5 through FIG. 8 has several advantages. For example, the continuous waves 318 of the plate 310 can cause the fluid that passes through the fluid passages 330 to continuously mix and turbulate as the fluid traverses through the thermal device 300. This mixing and turbulating can increase the effectiveness of the thermal device 300. In contrast, the thermal device 300′ of FIG. 3 features a flat plate 310′ that does not cause the fluid to continuously mix and turbulate as the fluid traverses through the fluid passages 330′ of the thermal device 300′. Instead, the fluid that passes through the fluid passages 330′ of the thermal device 300′ is generally a laminar flow.

Additionally, the continuous wave 318 of the plate 310 can allow for higher pressures of the fluid that passes through the fluid passages 330. For example, the thermal device 300 may be able to withstand pressures of five hundred psi or higher, such as between five hundred psi and up to three thousand psi, such as between eight hundred psi and up to two thousand psi. More specifically, the arches of the continuous wave 318 can create a surface that is mechanically stronger than the flat surface of the thermal device 300′ of FIG. 3.

Referring now to FIG. 9, a partial, side view of the thermal device 300 of FIG. 5 on the build platform 132 of additive manufacturing machine 102 of FIG. 1 is depicted, according to at least one example embodiment. In this example, the thermal device 300 was fabricated on the build platform 132 of the additive manufacturing machine 102 and is shown still positioned on the build platform 132 as it was fabricated. As mentioned, additive manufacturing technology may fabricate an object 114, such as a thermal device 300, by building the object 114 point-by-point, layer-by-layer, typically in a vertical direction V, which is perpendicular to a horizontal direction H. The build platform 132 defines a plane that extends along the horizontal direction H.

In this example, the thermal device 300 was fabricated in an upward, vertical direction V. Also in this example, the thermal device 300 was fabricated such that the Z direction defined by the thermal device 300 is substantially parallel to the vertical direction V. Also, the plate 310, which each extends along a plane defined by the X and Y direction, is substantially perpendicular to the vertical direction V and parallel to the build platform 132. The pins 320, which extend in the Z direction, are each substantially parallel to the vertical direction V.

As mentioned with reference to FIG. 1, the additive manufacturing process may use energy beams 144a and/or 144b to melt or fuse sequential layers of powder material 120 to fabricate the thermal device 300. However, even though the melted portions of the powder material 120 are impacted by gravity, the amount of distortions caused by the additive manufacturing process is reduced as compared to the example provided in reference to FIG. 3 through FIG. 4D. More specifically, because the concave curves 314 of the plate 310 extend in directions that are not in the horizontal direction H, except for a miniscule portion at the vertex 316, the concave curves 314 may not experience as much drooping as a feature that extended in the horizontal direction, such as the pins 320 of the thermal device 300′ depicted in FIG. 3 through FIG. 4D. The reduction of drooping is due to the arch-shape of the concave curves 314 and the increased support that each layer of the melted or fused sequential layers of powder material 120 receives from the layers beneath them, as opposed to a feature that extends in the horizontal direction H.

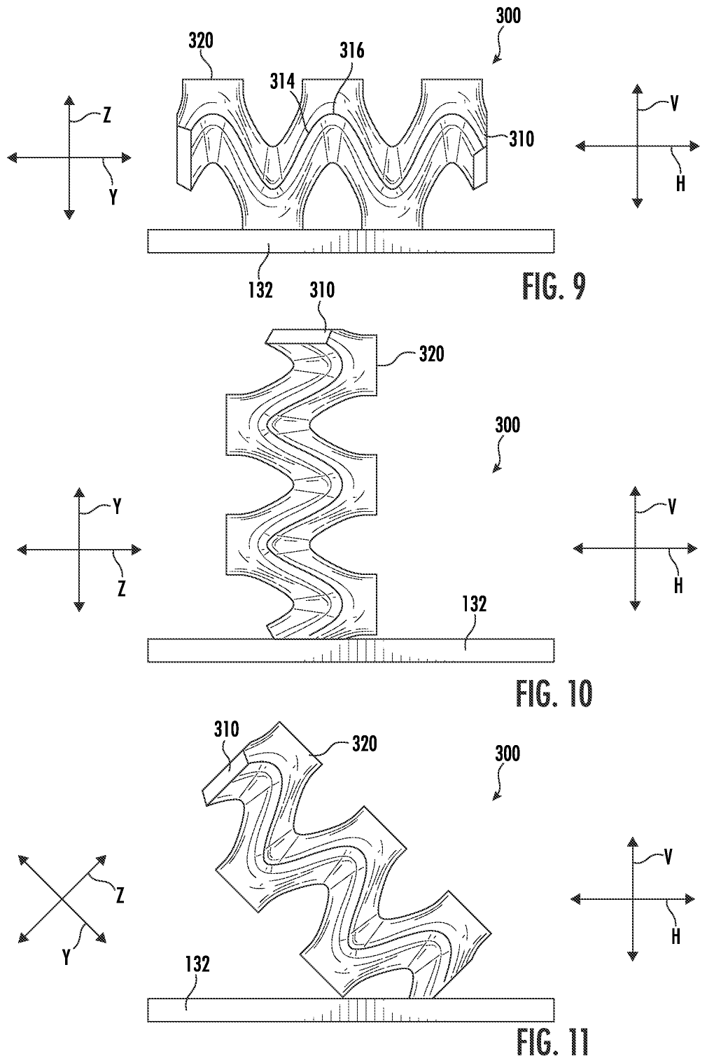

Referring now to FIG. 10, a partial, side view of the thermal device 300 of FIG. 5 on the build platform 132 is depicted, according to at least one example embodiment. In this example, the thermal device 300 was fabricated in an upward, vertical direction V. Also in this example, the thermal device 300 was fabricated such that the Z direction defined by the thermal device 300 is substantially perpendicular to the vertical direction V. Also, the plate 310, which each extends along a plane defined by the X and Y direction, is substantially parallel to the vertical direction V and perpendicular to the build platform 132. The pins 320, which extend in the Z direction, are each substantially perpendicular to the vertical direction V.

In this example, the pins 320 of the plate 310 may not experience as much drooping as the pins 320 of the thermal device 300′ depicted in FIG. 3 through FIG. 4D. Notably, in this orientation, the continuous wave of the plate 310 reduces the portion of the thermal device 300 that extends horizontally, as compared to the thermal device 300′ depicted in FIG. 3 through FIG. 4D. As such, the pins 320 of the thermal device 300 may experience a reduced amount of drooping.

Referring now to FIG. 11, a partial, side view of the thermal device 300 of FIG. 5 on the build platform 132 is depicted, according to at least one example embodiment. In this example, the thermal device 300 was fabricated in an upward, vertical direction V. Also in this example, the thermal device 300 was fabricated such that an angle between the Z direction defined by the thermal device 300 and the vertical direction V is about forty five degrees. Also, the plate 310, which each extends along a plane defined by the X and Y direction, extends at about a forty five degree angle in relation to the vertical direction V. The pins 320, which extend in the Z direction, extend at a forty five degree angle in relation to the vertical direction V. Even though a forty five degree angle is depicted, all other angles are contemplated from zero to ninety degrees, such as between fifteen degrees and seventy five degrees, such as between thirty degrees and sixty degrees.

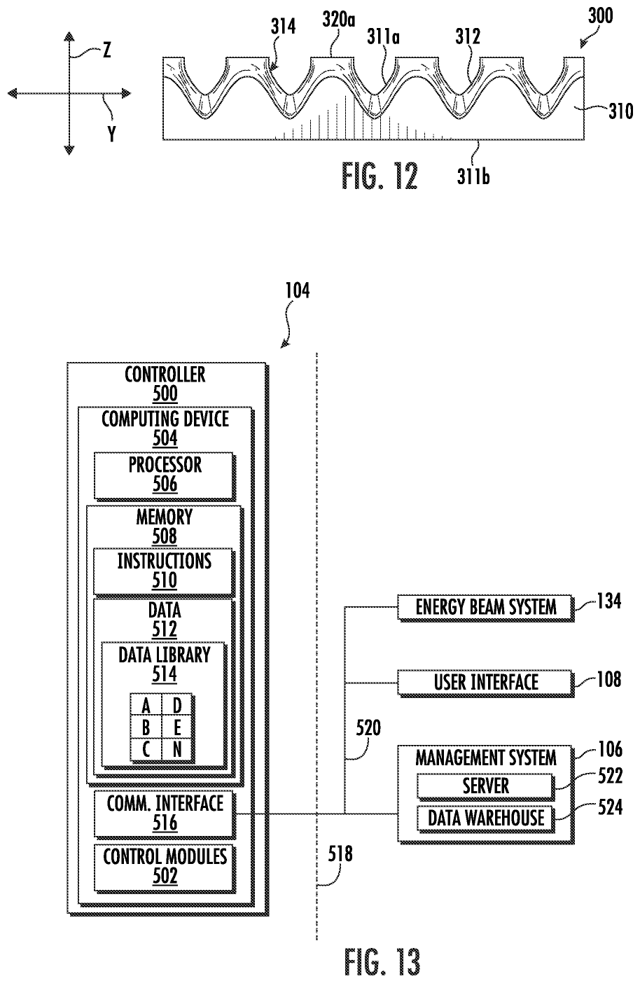

Referring now to FIG. 12, a partial, cross-sectional, side view of a thermal device 300 is shown, according to at least one example embodiment. The thermal device 300 in this example can be similar to the thermal device 300 of FIG. 5. For example, the thermal device 300 can include a plate 310 that has a first surface 311a and a second surface 311b. The thermal device 300 can define a plurality of convex curves 312 and a plurality of concave curves 314. Each convex curve 312 can be positioned between a pair of adjacent concave curves 314 of the plurality of concave curves 314, and each concave curve 314 can be positioned between a pair of adjacent convex curves 312 of the plurality of convex curves 312. The thermal device 300 can include a first plurality of pins 320a. Each pin 320 of the first plurality of pins 320a can extend from the vertex 316 of a different concave curve 314 of the plurality of concave curves 314 and extends away from the plate 310, in the upward direction, as shown.

The thermal device 300 of FIG. 12 differs from the thermal device 300 of FIG. 5 in that it does not include a second plurality of pins 320b that extend from the vertex 316 of the convex curves 312. Instead, the side of the thermal device 300 that does not include the first plurality of pins 320a, the second surface 311b, is substantially smooth and/or flat. The thermal device 300 may be incorporated into an airfoil. For example, the thermal device 300 may be incorporated into a vane 22 or a blade 24, as described in U.S. application Ser. No. 09/286,802, filed Apr. 6, 1999 (“Lee”), which is hereby incorporated by reference in its entirety. More specifically, the plurality of pins 320 can replace the ridges 44 of Lee.

Referring now to FIG. 13, an exemplary control system 104 will be described. The control system 104 may be configured to perform one or more control operations associated with the additive manufacturing system 100 and/or the additive manufacturing machine 102 of FIG. 1. The control operations may include one or more control commands configured to control operations of the energy beam system 134.

As shown in FIG. 13, the exemplary control system 104 includes a controller 500. The controller 500 may include one or more control modules 502 configured to cause the controller 500 to perform one or more control operations. The one or more control modules 502 may include control logic executable to provide control commands configured to control one or more controllable components associated with the additive manufacturing machine 102, such as controllable components associated with the energy beam system 134 and/or the imaging system 158. For example, the control module 502 may be configured to provide one or more control commands executable to control operation of one or more components of the energy beam system 134 and/or the irradiation device 142, such as a working beam generation device, a modulation beam generation device, a solid-state optical modulator, a beam modulator, a power source, and/or a temperature control element, and/or any one or more other components thereof.

The controller 500 may be communicatively coupled with the additive manufacturing machine 102. The controller 500 may be communicatively coupled with one or more components of the additive manufacturing machine 102, such as one or more components of the energy beam system 134 and/or the irradiation device 142, such as the working beam generation device 200, the modulation beam generation device 202, the solid-state optical modulator 204, the beam modulator 222, the power source 218, and/or the temperature control element 220, and/or any one or more other elements thereof. The controller 500 may also be communicatively coupled with the management system 106 and/or the user interface 108.

The controller 500 may include one or more computing devices 504, which may be located locally or remotely relative to the additive manufacturing machine 102, the energy beam system 134, and/or the irradiation device 142. The one or more computing devices 504 may include one or more processors 506 and one or more memory devices 508. The one or more processors 506 may include any suitable processing device, such as a microprocessor, microcontroller, integrated circuit, logic device, and/or other suitable processing device. The one or more memory devices 508 may include one or more computer-readable media, including but not limited to non-transitory computer-readable media, RAM, ROM, hard drives, flash drives, and/or other memory devices 508.

As used herein, the terms “processor” and “computer” and related terms, such as “processing device” and “computing device”, are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. The memory device 508 may include, but is not limited to, a non-transitory computer-readable medium, such as a random access memory (RAM), and computer-readable nonvolatile media, such as hard drives, flash memory, and other memory devices 508. Alternatively, a floppy disk, a compact disc-read only memory (CD-ROM), a magneto-optical disk (MOD), and/or a digital versatile disc (DVD) may also be used.

As used herein, the term “non-transitory computer-readable medium” is intended to be representative of any tangible computer-based device implemented in any method or technology for short-term and long-term storage of information, such as, computer-readable instructions, data structures, program modules and sub-modules, or other data in any device. The methods described herein may be encoded as executable instructions embodied in a tangible, non-transitory, computer readable media, including, without limitation, a storage device and/or the memory device 508. Such instructions, when executed by a processor, cause the processor to perform at least a portion of the methods described herein. Moreover, as used herein, the term “non-transitory computer-readable medium” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The one or more memory devices 508 may store information accessible by the one or more processors 506, including computer-executable instructions 510 that can be executed by the one or more processors 506. The computer-executable instructions 510 may include any set of instructions which when executed by the one or more processors 506 cause the one or more processors 506 to perform operations, including optical element monitoring operations, maintenance operations, cleaning operations, calibration operations, and/or additive manufacturing operations.

The memory devices 508 may store data 512 accessible by the one or more processors 506. The data 512 can include current or real-time data 512, past data 512, or a combination thereof. The data 512 may be stored in a data library 514. As examples, the data 512 may include data 512 associated with or generated by the additive manufacturing system 100 and/or the additive manufacturing machine 102, including data 512 associated with or generated by the controller 500, the energy beam system 134, the imaging system 158, the management system 106, the user interface 108, and/or the computing device 504, such as operational data 512 and/or calibration data 512 pertaining thereto. The data 512 may also include other data sets, parameters, outputs, information, associated with the additive manufacturing system 100 and/or the additive manufacturing machine 102.

The one or more computing devices 504 may also include a communication interface 516, which may be used for communications with a communication network 518 via wired or wireless communication lines 520. The communication interface 516 may include any suitable components for interfacing with one or more network(s), including for example, transmitters, receivers, ports, controllers, antennas, and/or other suitable components. The communication interface 516 may allow the computing device 504 to communicate with various nodes on the communication network 518, such as nodes associated with the additive manufacturing machine 102, the energy beam system 134, the imaging system 158, the management system 106, and/or the user interface 108. The communication network 518 may include, for example, a local area network (LAN), a wide area network (WAN), SATCOM network, VHF network, a HF network, a Wi-Fi network, a WiMAX network, a gatelink network, and/or any other suitable communication network 518 for transmitting messages to and/or from the controller 500 across the communication lines 520. The communication lines 520 of communication network 518 may include a data bus or a combination of wired and/or wireless communication links.

The communication interface 516 may allow the computing device 504 to communicate with various components of the additive manufacturing system 100 and/or the additive manufacturing machine 102 communicatively coupled with the communication interface 516 and/or communicatively coupled with one another. The communication interface 516 may additionally or alternatively allow the computing device 504 to communicate with the management system 106 and/or the user interface 108. The management system 106 may include a server 522 and/or a data warehouse 524. As an example, at least a portion of the data 512 may be stored in the data warehouse 524, and the server 522 may be configured to transmit data 512 from the data warehouse 524 to the computing device 504, and/or to receive data 512 from the computing device 504 and to store the received data 512 in the data warehouse 524 for further purposes. The server 522 and/or the data warehouse 524 may be implemented as part of the control system 104 and/or as part of the management system 106.

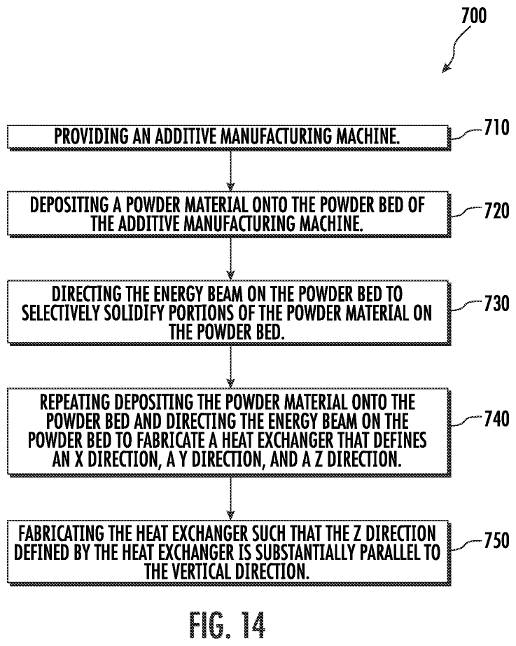

Referring now to FIG. 14, a method 700 of additively manufacturing a thermal device 300 is depicted, according to one example embodiment. The method may be performed at least in part by the control system 104, and/or one or more control modules 502 associated with the control system 104. Additionally, or in the alternative, exemplary methods may be performed at least in part by the additive manufacturing system 100 and/or the additive manufacturing machine 102, for example, by the control system 104 associated therewith.

As shown, the method 700 can include a step 710 of providing an additive manufacturing machine, such as the additive manufacturing machine 102 as described in reference to FIG. 1. It will be appreciated, that as used herein, the term “providing” simply means making available, and does not require any manufacturing, assembly, delivery, etc. The method can include a step 720 of depositing the powder material 120 onto the powder bed 138 of the additive manufacturing machine 102. The method 700 can include the step 730 of directing the energy beams 144a and/or 144b on the powder bed 138 to selectively solidify portions of the powder material 120 on the powder bed 138. The method 700 can include a step 740 of repeating depositing the powder material 120 onto the powder bed 138 and directing the energy beams 144a and/or 144b on the powder bed 138 to fabricate a thermal device 300 that defines an X direction, a Y direction, and a Z direction.

In this example, the step 740 of repeating depositing the powder material 120 onto the powder bed 138 and directing the energy beams 144a and/or 144b on the powder includes a step 750 of fabricating the thermal device 300 such that the Z direction defined by the thermal device 300 is substantially parallel to the vertical direction, as depicted in FIG. 9.

In at least one other example, the step 740 of repeating depositing the powder material 120 onto the powder bed 138 and directing the energy beams 144a and/or 144b on the powder includes fabricating the thermal device 300 such that the Z direction defined by the thermal device 300 is substantially perpendicular to the vertical direction, as depicted in FIG. 10.

In at least one other example, the step of repeating depositing the powder material 120 onto the powder bed 138 and directing the energy beams 144a and/or 144b on the powder includes fabricating the thermal device 300 such that an angle between the Z direction defined by the thermal device 300 and the vertical direction is between thirty degrees and sixty degrees, as depicted in FIG. 11.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A thermal device comprising a plate defining a plurality of convex curves and a plurality of concave curves, each convex curve positioned between a pair of adjacent concave curves of the plurality of concave curves, and each concave curve positioned between a pair of adjacent convex curves of the plurality of convex curves, each concave curve defining a vertex, and a plurality of pins, each pin of the plurality of pins extending from the vertex of a different concave curve of the plurality of concave curves and extending away from the plate.

The thermal device of one or more of these clauses, wherein the plurality of pins is a first plurality of pins, wherein each convex curve defines a vertex, and wherein the thermal device further comprises a second plurality of pins, each pin of the second plurality of pins extending from the vertex of a different convex curve of the plurality of convex curves and extending away from the plate.

The thermal device of one or more of these clauses, wherein the plate is a first plate, and wherein the thermal device further comprises a second plate defining a second plurality of convex curves and a second plurality of concave curves, each convex curve positioned between a pair of adjacent concave curves of the second plurality of concave curves, and each concave curve positioned between a pair of adjacent convex curves of the second plurality of convex curves, each concave curve defining a vertex, and a third plurality of pins, each pin of the third plurality of pins extending from the vertex of a different concave curve of the second plurality of concave curves and extending away from the second plate and towards the first plate, each of the pins of the third plurality of pins being connected to a different pin of the second plurality of pins.

The thermal device of one or more of these clauses, wherein the first plate and the second plate define a fluid passage therebetween.

The thermal device of one or more of these clauses, wherein the plate is a unitary component and defines a first continuous wave comprising the plurality of concave curves and the plurality of convex curves.

The thermal device of one or more of these clauses, wherein the first continuous wave extends in a first direction, wherein the plate defines a second continuous wave comprising a second plurality of concave curves and a second plurality of convex curves, the second continuous wave extending in a second direction, an angle between the first direction and the second direction being between seventy and one-hundred and ten degrees.

The thermal device of one or more of these clauses, wherein each concave curve of the plurality of concave curves defines a wave amplitude and each pin of the plurality of pins defines a pin height, wherein a ratio between at least one of the pin heights and at least one of the wave amplitudes is at least 1:1.

The thermal device of one or more of these clauses, wherein the plate has a thickness, wherein the thickness of the plate is greater than or equal to 0.010 inch.

The thermal device of one or more of these clauses, wherein each pin of the plurality of pins has a pin diameter and each pin of the plurality of pins has a pin height, wherein a ratio between at least one of the pin heights and at least one of the pin diameters is greater than or equal to 1:1 and less than or equal to 4:1.

The thermal device of one or more of these clauses, wherein each pin of the plurality of pins has a pin height and the plate has a thickness, wherein a ratio between a least one of the pin heights and the thickness of the plate is less than or equal to 1:1.

A gas turbine engine having a compressor section, a combustion section, and a turbine section, the gas turbine engine comprising a heat generating component, a thermal device in thermal communication with the heat generating component, wherein the thermal device comprises a plate defining a plurality of convex curves and a plurality of concave curves, each convex curve positioned between a pair of adjacent concave curves of the plurality of concave curves, and each concave curve positioned between a pair of adjacent convex curves of the plurality of convex curves, each concave curve defining a vertex, and a plurality of pins, each pin of the plurality of pins extending from the vertex of a different concave curve of the plurality of concave curves and extending away from the plate.

The gas turbine engine of one or more of these clauses, wherein the plurality of pins is a first plurality of pins, wherein each convex curve defines a vertex, and wherein the thermal device further comprises a second plurality of pins, each pin of the second plurality of pins extending from the vertex of a different convex curve of the plurality of convex curves and extending away from the plate.

The gas turbine engine of one or more of these clauses, wherein the plate is a first plate, and wherein the thermal device further comprises a second plate defining a second plurality of convex curves and a second plurality of concave curves, each convex curve positioned between a pair of adjacent concave curves of the second plurality of concave curves, and each concave curve positioned between a pair of adjacent convex curves of the second plurality of convex curves, each concave curve defining a vertex, and a third plurality of pins, each pin of the third plurality of pins extending from the vertex of a different concave curve of the second plurality of concave curves and extending away from the second plate and towards the first plate, each of the pins of the third plurality of pins being connected to a different pin of the second plurality of pins.

The gas turbine engine of one or more of these clauses, wherein the first plate and the second plate define a fluid passage therebetween.

The gas turbine engine of one or more of these clauses, wherein the plate is a unitary component and defines a first continuous wave comprising the plurality of concave curves and the plurality of convex curves.

The gas turbine engine of one or more of these clauses, wherein each concave curve of the plurality of concave curves defines a wave amplitude and each pin of the plurality of pins defines a pin height, wherein a ratio between at least one of the pin heights and at least one of the wave amplitudes is at least 1:1.

A method of additively manufacturing a thermal device with an additive manufacturing machine, the additive manufacturing machine defining a vertical direction and a horizontal direction and comprising a build platform, the build platform defining a plane that extends along the horizontal direction, the method comprising depositing a powder material onto a powder bed of the additive manufacturing machine, directing an energy beam of the additive manufacturing machine on the powder bed to selectively solidify portions of the powder material on the powder bed, and repeating depositing the powder material onto the powder bed and directing the energy beam on the powder bed to fabricate a thermal device that defines an X direction, a Y direction, and a Z direction, the thermal device comprising a plate extending, at least partially, along a plane defined by the X direction and the Y direction, the plate defining a plurality of convex curves and a plurality of concave curves, each convex curve positioned between a pair of adjacent concave curves of the plurality of concave curves, and each concave curve positioned between a pair of adjacent convex curves of the plurality of convex curves, each concave curve defining a vertex, and a plurality of pins, at least one pin of the plurality of pins extending in the Z direction and extending from the vertex of a different concave curve of the plurality of concave curves and extending away from the plate.

The method of one or more of these clauses, wherein repeating depositing the powder material onto the powder bed and directing the energy beam on the powder comprises fabricating the thermal device such that the Z direction defined by the thermal device is substantially parallel to the vertical direction.

The method of one or more of these clauses, wherein repeating depositing the powder material onto the powder bed and directing the energy beam on the powder comprises fabricating the thermal device such that the Z direction defined by the thermal device is substantially perpendicular to the vertical direction.

The method of one or more of these clauses, wherein repeating depositing the powder material onto the powder bed and directing the energy beam on the powder comprises fabricating the thermal device such that an angle between the Z direction defined by the thermal device and the vertical direction is between thirty degrees and sixty degrees.

We claim:

1. A thermal device comprising:
a plate defining a plurality of convex curves and a plurality of concave curves, each convex curve positioned between a pair of adjacent concave curves of the plurality of concave curves, and each concave curve positioned between a pair of adjacent convex curves of the plurality of convex curves, each concave curve defining a vertex; and
a plurality of pins, each pin of the plurality of pins extending from the vertex of a different concave curve of the plurality of concave curves and extending away from the plate.

2. The thermal device of claim 1, wherein the plurality of pins is a first plurality of pins, wherein each convex curve defines a vertex, and wherein the thermal device further comprises:
a second plurality of pins, each pin of the second plurality of pins extending from the vertex of a different convex curve of the plurality of convex curves and extending away from the plate.

3. The thermal device of claim 2, wherein the plate is a first plate, and wherein the thermal device further comprises:
a second plate defining a second plurality of convex curves and a second plurality of concave curves, each convex curve positioned between a pair of adjacent concave curves of the second plurality of concave curves, and each concave curve positioned between a pair of adjacent convex curves of the second plurality of convex curves, each concave curve defining a vertex; and
a third plurality of pins, each pin of the third plurality of pins extending from the vertex of a different concave curve of the second plurality of concave curves and extending away from the second plate and towards the first plate, each of the pins of the third plurality of pins being connected to a different pin of the second plurality of pins.

4. The thermal device of claim 3, wherein the first plate and the second plate define a fluid passage therebetween.

5. The thermal device of claim 1, wherein the plate is a unitary component and defines a first continuous wave comprising the plurality of concave curves and the plurality of convex curves.

6. The thermal device of claim 5, wherein the first continuous wave extends in a first direction, wherein the plate defines a second continuous wave comprising a second plurality of concave curves and a second plurality of convex curves, the second continuous wave extending in a second direction, an angle between the first direction and the second direction being between seventy and one-hundred and ten degrees.

7. The thermal device of claim 1, wherein each concave curve of the plurality of concave curves defines a wave amplitude and each pin of the plurality of pins defines a pin height, wherein a ratio between at least one of the pin heights and at least one of the wave amplitudes is at least 1:1.

8. The thermal device of claim 1, wherein the plate has a thickness, wherein the thickness of the plate is greater than or equal to 0.010 inch.

9. The thermal device of claim 1, wherein each pin of the plurality of pins has a pin diameter and each pin of the plurality of pins has a pin height, wherein a ratio between at least one of the pin heights and at least one of the pin diameters is greater than or equal to 1:1 and less than or equal to 4:1.

10. The thermal device of claim 1, wherein each pin of the plurality of pins has a pin height and the plate has a thickness, wherein a ratio between a least one of the pin heights and the thickness of the plate is less than or equal to 1:1.

11. A gas turbine engine having a compressor section, a combustion section, and a turbine section, the gas turbine engine comprising:
a heat generating component;
a thermal device in thermal communication with the heat generating component, wherein the thermal device comprises:
a plate defining a plurality of convex curves and a plurality of concave curves, each convex curve positioned between a pair of adjacent concave curves of the plurality of concave curves, and each concave curve positioned between a pair of adjacent convex curves of the plurality of convex curves, each concave curve defining a vertex; and
a plurality of pins, each pin of the plurality of pins extending from the vertex of a different concave curve of the plurality of concave curves and extending away from the plate.

12. The gas turbine engine of claim 11, wherein the plurality of pins is a first plurality of pins, wherein each convex curve defines a vertex, and wherein the thermal device further comprises:
a second plurality of pins, each pin of the second plurality of pins extending from the vertex of a different convex curve of the plurality of convex curves and extending away from the plate.

13. The gas turbine engine of claim 12, wherein the plate is a first plate, and wherein the thermal device further comprises:
a second plate defining a second plurality of convex curves and a second plurality of concave curves, each convex curve positioned between a pair of adjacent concave curves of the second plurality of concave curves, and each concave curve positioned between a pair of adjacent convex curves of the second plurality of convex curves, each concave curve defining a vertex; and
a third plurality of pins, each pin of the third plurality of pins extending from the vertex of a different concave curve of the second plurality of concave curves and extending away from the second plate and towards the first plate, each of the pins of the third plurality of pins being connected to a different pin of the second plurality of pins.

14. The gas turbine engine of claim 13, wherein the first plate and the second plate define a fluid passage therebetween.

15. The gas turbine engine of claim 11, wherein the plate is a unitary component and defines a first continuous wave comprising the plurality of concave curves and the plurality of convex curves.

16. The gas turbine engine of claim 11, wherein each concave curve of the plurality of concave curves defines a wave amplitude and each pin of the plurality of pins defines a pin height, wherein a ratio between at least one of the pin heights and at least one of the wave amplitudes is at least 1:1.

17. A method of additively manufacturing a thermal device with an additive manufacturing machine, the additive manufacturing machine defining a vertical direction and a horizontal direction and comprising a build platform, the build platform defining a plane that extends along the horizontal direction, the method comprising:
depositing a powder material onto a powder bed of the additive manufacturing machine;
directing an energy beam of the additive manufacturing machine on the powder bed to selectively solidify portions of the powder material on the powder bed; and
repeating depositing the powder material onto the powder bed and directing the energy beam on the powder bed to fabricate a thermal device that defines an X direction, a Y direction, and a Z direction, the thermal device comprising:
a plate extending, at least partially, along a plane defined by the X direction and the Y direction, the plate defining a plurality of convex curves and a plurality of concave curves, each convex curve positioned between a pair of adjacent concave curves of the plurality of concave curves, and each concave curve positioned between a pair of adjacent convex curves of the plurality of convex curves, each concave curve defining a vertex; and
a plurality of pins, at least one pin of the plurality of pins extending in the Z direction and extending from the vertex of a different concave curve of the plurality of concave curves and extending away from the plate.

18. The method of claim 17, wherein repeating depositing the powder material onto the powder bed and directing the energy beam on the powder comprises fabricating the thermal device such that the Z direction defined by the thermal device is substantially parallel to the vertical direction.

19. The method of claim 17, wherein repeating depositing the powder material onto the powder bed and directing the energy beam on the powder comprises fabricating the thermal device such that the Z direction defined by the thermal device is substantially perpendicular to the vertical direction.

20. The method of claim 17, wherein repeating depositing the powder material onto the powder bed and directing the energy beam on the powder comprises fabricating the thermal device such that an angle between the Z direction defined by the thermal device and the vertical direction is between thirty degrees and sixty degrees.
